(19) United States
(12) Patent Application Publication
(10) Pub. No.: US 2026/0318539 A1
(43) Pub. Date: Oct. 15, 2026

(54) ELECTRICAL HOUSEHOLD APPLIANCE HAVING AN OPERATING ARRANGEMENT WITH AN ILLUMINATION

(71) Applicant: BHS Hausgeräte GmbH, Munich (DE)

(72) Inventors: Alvaro Martinez Diez, Peñacastillo (Santander) (ES); Emilio Placer Maruri, Liencres (ES)

(21) Appl. No.: 19/486,084

(22) PCT Filed: May 28, 2024
(86) PCT No.: PCT/EP2024/064579

§ 371 Date: Nov. 20, 2025

(30) Foreign Application Priority Data
May 31, 2023 (EP) 23382513.2

(51) Int. Cl. F24C 3/12; G05G 1/10

(52) U.S. Cl. CPC F24C 3/124; G05G 1/105

(57) ABSTRACT

An electrical household appliance with a control panel includes a surface plate with an operating arrangement having: an opening or letting through a control shaft of a controller placed inside the electrical household appliance, at least a first visualisation window close to the opening, an operating element connected to the control shaft to operate the controller, a light-emitting component, placed inside the electrical household appliance, and a light-guiding component, arranged between the light-emitting component and the surface plate, having a light-guiding element and a shielding element. For a better visualisation of the control panel of the appliance, the light-guiding component is fixed to a plate inner face of the surface plate, at least over a part of the shielding element-surrounding the light-guiding element, in such a manner that the light emitted by the light-emitting component can flow out of the electrical household appliance only through the first visualisation window.

The invention relates to the field of electrical household appliances with a control panel comprising a surface plate with at least an operating arrangement having an opening for letting through a control shaft of a controller placed inside the electrical household appliance, at least a first visualisation window close to the opening, an operating element connected to the control shaft to operate the controller, a light-emitting component, placed inside the electrical household appliance, and a light-guiding component, arranged between the light-emitting component and the surface plate, having a light-guiding element and a shielding element, wherein the light-guiding element has a light incidence surface facing the light-emitting component, a light outflow surface facing the surface plate, and a side surface entirely surrounded by, and being in contact with, the shielding element in such a manner that a light emitted by the light-emitting component flows into the light-guiding element through the light incidence surface and is led to the light outflow surface and to the side surface and can flow through the light outflow surface out of the electrical household appliance through the first visualisation window of the surface plate and the shielding element blocks the outflow of light led to the side surface into the electrical household appliance.

EP 2 985 532 A describes an electrical household appliance having at least a control panel, a rotation axis, an operating element and a light-emitting component. Furthermore, the electrical household appliance includes a light-guiding component connected to the rotation axis and rotating being actuated by the rotation axis when the rotation axis rotates, and the light-guiding component is located between the light-emitting component and the panel. The light-guiding component includes a light incidence surface facing the light-emitting component and a light outflow surface facing the panel, and the light from the light-emitting component flows into the light-guiding component through the light incidence surface and is emitted to the control panel from the light outflow surface.

The object of the invention is to provide an electrical household appliance having a control panel with an improved illumination.

This object is achieved by an electrical household appliance with a control panel comprising a surface plate with at least an operating arrangement having an opening for letting through a control shaft of a controller placed inside the electrical household appliance, at least a first visualisation window close to the opening, an operating element connected to the control shaft to operate the controller, a light-emitting component, placed inside the electrical household appliance, and a light-guiding component, arranged between the light-emitting component and the surface plate, having a light-guiding element and a shielding element, wherein the light-guiding element has a light incidence surface facing the light-emitting component, a light outflow surface facing the surface plate, and a side surface entirely surrounded by, and being in contact with, the shielding element in such a manner that a light emitted by the light-emitting component flows into the light-guiding element through the light incidence surface and is led to the light outflow surface and to the side surface and can flow through the light outflow surface out of the electrical household appliance through the first visualisation window of the surface plate and the shielding element blocks the outflow of light led to the side surface into the electrical household appliance. The light-guiding component is fixed to a plate inner face of the surface plate, at least over a part of the shielding element surrounding the light-guiding element, in such a manner that the light emitted by the light-emitting component can flow out of the electrical household appliance only through the first visualisation window.

With a light-guiding component like the one from the invention, light loss is minimised to the extent possible inside the appliance and focused outwards through the first visualisation window.

The control panel is the operating panel of the electrical household appliance and may be a component fixedly connected to the appliance or independent, horizontally or vertically mounted. If it forms part of the electrical household appliance in a horizontal position, the surface plate of the panel can be the surface plate of the electrical household appliance. The operating arrangement is formed by a set of control panel elements by means of which the electrical household appliance can be controlled. The main elements of the operating arrangement are an operating element that can be operated by the user from outside the appliance by pressing or rotating it, a controller of the electrical household appliance arranged inside the appliance and connected to the operating element by means of a control shaft extending through the surface plate via an opening and, to provide an illumination through a first visualisation window in the surface plate, a light-emitting component and a light-guiding component inside the appliance. The light-emitting component is preferably a LED bulb but it can be any light-emitting component, either electrical or chemical luminescent. The surface plate is mostly opaque, so light cannot flow through the same. The first visualisation window is made in the surface plate close to the opening for letting through the control shaft and allows light to flow into and out of the electrical household appliance. The light-guiding component is arranged between the light-emitting component and a plate inner face of the surface plate. The light-guiding component has a top side facing the plate inner face, a bottom side facing the light-emitting component and an external lateral side laterally facing the interior of the appliance. To guide light from the light-emitting component to the first visualisation window, the light-guiding component has a light-guiding element that can be made of a low-cost plastic material such as methacrylate, polycarbonate or the like, but any material having light-transmitting properties would be valid. To prevent light from diffusing over the interior of the appliance, the light-guiding component has a shielding element surrounding the light-guiding element and blocking the light outflow through the side surface. The light-guiding element has a light incidence surface facing the light-emitting component and preferably close to the same. The light-guiding element has a light outflow surface facing the surface plate and preferably close to the same and preferably close to the first visualisation window. Both light incidence and outflow surfaces are preferably flat and even and preferably parallel to each other at least partially. In addition, the light-guiding element has a side surface arranged between the light incidence surface and the light outflow surface and may be inclined towards one of both light incidence or outflow surfaces but it is preferably orthogonal to both of them. The shielding element blocks the light outflow through the side surface into the appliance since, as the light-guiding element is entirely surrounded by the same, all of the light guided through the light-guiding element towards the side surface ends up impinging on the shielding element. Preferably, the shielding element is in direct contact with the side surface of the light-guiding element. Preferably, the shielding element extends over the top side of the light-guiding component facing the plate inner face. The light-guiding component is joined to the plate inner face at least by means of the shielding element surrounding the entire light-guiding element. It may be fixed with an intermediate adhesive or by a holding device keeping the light-guiding component in an immovable contact against the surface plate, for example with a sealing gasket surrounding the opening of the operating arrangement. In this manner, the light emitted by the light-emitting component flows in through the light incidence surface and flows out of the light guide through the light outflow surface to the first visualisation window and not through the side surface.

To occupy less space inside the appliance, the light-guiding component is substantially plate-shaped such as disc-shaped or having the shape of a quadrangular or polygonal sheet. And for a better transmission of light towards the first visualisation window, the light-guiding element is in contact with the plate inner face of the surface plate, preferably at least in contact with the first visualisation window.

When the light-guiding component surrounds the opening, it is provided that the light-guiding component has an orifice surrounding the opening and a second shielding element in contact with the plate inner face over the entire perimeter of the orifice in such a manner that it blocks the outflow of light emitted by the light-emitting component led to the orifice towards the opening. In this manner, undesired light leakages through the opening can be avoided as well.

Furthermore, it is provided that the surface plate has a second visualisation window through which the shielding element can be seen at least partially from outside the electrical household appliance, and the shielding element blocks the light outflow through the second visualisation window in such a manner that a part of the shielding element is visible through the second visualisation window and a part of the light-guiding element is visible through the first visualisation window. Thus, from outside the appliance, the second visualisation window can be distinguished while looking at the surface plate when the shielding element differs in colour or texture from that of the surface plate. Moreover, it is provided that the shielding element is opaque and of a colour and/or texture different from that of the plate, to emphasise the second visualisation window from outside the appliance when looking at the surface plate.

It is also interesting that the shielding element covers at least a part of the light incidence surface of the light guide, provided that the light impinging on the light incidence surface is enough to flow out of the appliance via the first visualisation window through the light outflow surface of the light guide and remains blocked by the shielding element and cannot flow out through the light incidence surface to the extent possible.

In a configuration, it is provided that at least a part of the shielding element is an opaque solid piece, preferably made of plastic or the like, fitting in a positive-fit connection with the light-guiding element. Thereby, the light-guiding component and the light-guiding element are provided with strength and protection respectively.

Furthermore, it may occur that at least a part of the shielding element is an opaque paint layer and/or made of an opaque plastic piece or the like and covers at least a part of the light outflow surface. It might occur that the shielding element is made entirely as an opaque paint layer adhered to at least a part of the surfaces of the light-guiding element or a combination of a solid piece and a paint layer.

In an operating arrangement, it is desirable that both the first visualisation window and the second visualisation window are arranged around the opening to give information to the user when he/she actuates the operating element, and more specifically when the operating element can rotate about the control shaft and the positions of the operating element indicate different functions of the electrical household appliance, the visualisation windows around the opening and close to the same provide a very useful indication to the user. “Around the opening” refers to a distance such that the position of the operating element can be related to at least one of both visualisation windows, since an indication of information for the user is represented in at least one of the visualisation windows.

There are several implementations of surface plates depending on the type of an electrical household appliance and, above all, depending on the appearance of the same. Sometimes, the surface plate is made of a metal sheet, so the visualisation windows need to be sheet cut-outs, either just one cut-out or several contiguous cut-outs, even as micro-perforations allowing light to flow through them and the light-guiding element or the shielding element to be seen. In other cases, the surface plate may be made at least partially of an opaque glass and the visualisation windows are transparent and/or translucent in this case, these allowing light to flow through them and the light-guiding element or the shielding element to be seen.

To focus and lead light emitted by the light-emitting component, a shield is provided surrounding it and focusing light towards the light incidence surface of the light-guiding component. The inside of this shield may be made of a reflective material and it may have a truncated conical shape, wherein its narrowest base diameter surrounds the light-emitting component and its biggest base diameter is close to or in contact with the light-guiding component.

Furthermore, the electrical household appliance has at least a control panel with at least two adjacent operating arrangements by means of which the corresponding controllers are operated.

This invention is particularly useful in electrical household appliances like a gas cooking appliance, in which the controller is a gas tap.

Further advantages can be derived from the following description of the figures. One embodiment of the invention is represented in the figures. The figures, the description and the patent claims contain numerous combined features. The person skilled in the art shall also advantageously consider the features separately and combine them into further reasonable combinations.

These show in:

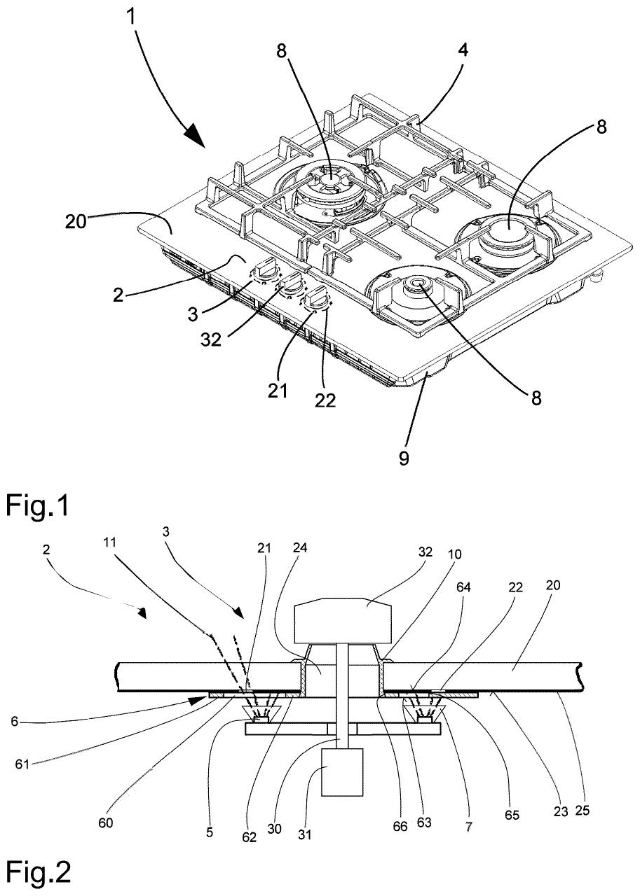

FIG. 1 shows a perspective view of an electrical household appliance,

FIG. 2 shows an elevation view of a section of the operating arrangement of the appliance from FIG. 1,

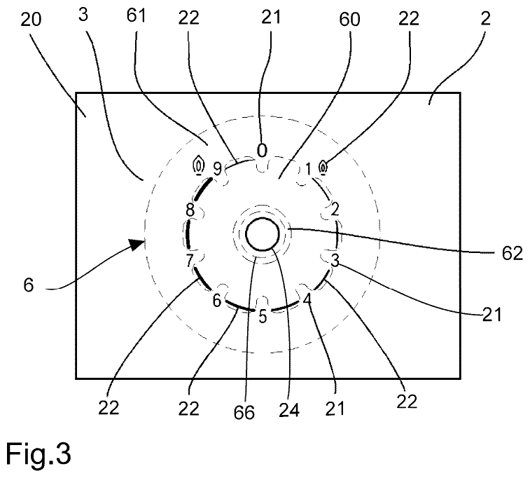

FIG. 3 shows a plan view of a surface plate of the operating arrangement from FIG. 2,

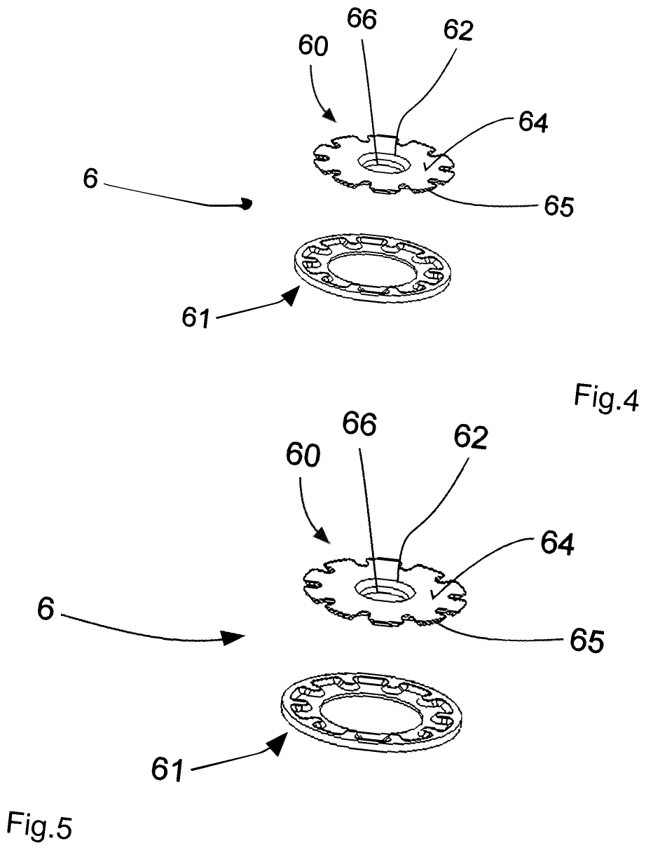

FIG. 4 shows an exploded view of a configuration of a light-guiding component, and

FIG. 5 shows a perspective view of a light-guiding component.

FIG. 1 shows an electrical household gas cooking appliance 1 in the form of a gas cooking hob provided to be inserted into a receiving opening of a kitchen worktop. The gas cooking hob 1 can be a part of a household appliance, and comprises a cooking hob housing 9 and a surface plate 20 arranged spaced apart from the cooking hob housing 9. The surface plate can be also named covering plate. The covering plate 20 is a metal, glass, ceramics or glass-ceramics plate and has a control panel 2 on which three operating arrangements 3 with their respective operating elements 32 are located, by means of which the user can operate the controllers in the form of gas taps arranged in the internal space of the electrical household appliance 1 under the surface plate 20. Furthermore, the operating arrangements have in the surface plate 20 several firsts visualisation windows 21 and several second visualisation windows 22 around the operating elements 32.

There are three gas burners 8 and two pan supports 4 on the surface plate 20 of the electrical household appliance 1. The surface plate 20 is connected at its bottom side to the housing 9. Thereby, the internal space of the electrical household appliance 1 is defined, in which a part of the functional elements of the electrical household appliance 1 such as gas collecting pipes, gas taps and nozzle holders are arranged.

FIG. 2 shows a side view section of one of the operating arrangements 3 of the electrical household appliance 1 of the invention forming part of the control panel 2 of the same and wherein the surface plate 20 is made of glass and, on its plate inner face 23 facing the inside of the electrical household appliance 1, there is a coating making it opaque to the light flow-through except for in the first visualisation window 21 and the second visualisation window 22. The surface plate 20 has an opening 24 through which the control shaft 30 of the controller 31 in the form of a gas tap arranged inside the electrical household appliance 1 extends. The operating element 32 for controlling the controller 31 is fixed to the other end of the control shaft 30. There is a sealing gasket 10 in the opening 24 to prevent liquids spilt over the surface plate 20 from entering the electrical household appliance 1.

An electronic board is arranged over the controller 31 having a light-emitting component 5 in the form of a LED and surrounded by a shield 7 to lead the light beam 11 to the plate inner face 23. The light-guiding component 6 fixed to the plate inner face 23 through the sealing gasket 10 is arranged between the surface plate 20 and the light-emitting component 5 and surrounding the opening 24. The light-guiding component 6 has an orifice 66 around the opening 24 for letting through the control shaft 30 by means of which it is connected to the sealing gasket 10 to remain fixedly connected to the plate inner face 23. The surface plate 20 is made of a transparent or translucent glass and, on its plate inner face 23, it has an opaque coating 25 not allowing light to flow through over its entire surface except for in the visualisation windows 21 and 22, through which the light-guiding component 6 can be seen. Furthermore, the light-guiding component 6 has a light-guiding element 60 and a first shielding element 61 around the light-guiding element 60 and a second shielding element 62 around the orifice 66 by means of which it is connected to the sealing gasket 10 and fixed to the plate inner face 23. The light-guiding element 60 can be seen through the first visualisation window 21 and the shielding element 61 can be seen through the second visualisation window 22. Since the light-guiding element 60 is translucent, the light beam 11 coming from the light-emitting component 5 flows through it and can flow out of the electrical household appliance 1 through the first visualisation window 21. Since the shielding element 61 is opaque, only this can be seen through the second visualisation window 22, especially when it is made in a different colour from that of the coating 25.

FIG. 3 shows a plan view of a part of the control panel 2 of the operating arrangement 3 without the operating element 32 or the control shaft 30 being shown in this figure. The surface plate 20 and its opening 24 are shown. The light-guiding component 6 is shown in a dashed line, which is placed behind the surface plate 20 inside the electrical household appliance 1. The light-guiding component 6 is ring-shaped and externally has a shielding element 61 surrounding it and in contact with the light-guiding element 60 and internally has a second shielding element 62 delimiting the orifice 66 of the light-guiding component 6. The visualisation windows 21 and 22, which are superimposed on the light-guiding component 6, can be seen from outside the electrical household appliance 1. This has multiple firsts visualisation windows 21 superimposed on the light-guiding element 60 and multiple second visualisation windows 22 superimposed on the shielding element 61.

FIG. 4 and FIG. 5 show an embodiment of a disc-shaped light-guiding component 6 having a central orifice 66, which is made up of separable pieces connectable to each other in a positive-fit connection. The light-guiding element 60 has the shape of a toothed wheel and the second shielding element 62 is arranged in the central orifice 66. The side surface 65 of the light-guiding element 6 engages with the shielding element 61, which is plate-shaped. FIG. 6 shows the assembled light-guiding component 6 from its top face, wherein the light-guiding element 60 shows its light outflow surface 64 facing upwards.

### REFERENCE NUMERALS

1 electrical household appliance
10 sealing gasket
11 light beam
2 control panel
20 surface plate
21 first visualisation window
22 second visualisation window
23 plate inner face
24 opening
25 coating
3 operating arrangement
30 control shaft
31 controller
32 operating element
4 pan supports
5 light-emitting component
6 light-guiding component
60 light-guiding element
61 shielding element
62 second shielding element
63 light incidence surface
64 light outflow surface
65 side surface
66 orifice
7 shield
8 gas burner
9 housing

1-15. (canceled)

16. An electrical household appliance, comprising:
a surface plate comprising a control panel, an operating arrangement on the control panel, and an opening for letting through a control shaft of a controller placed inside the electrical household appliance, said operating arrangement comprising a first visualisation window close to the opening, and an operating element connected to the control shaft to operate the controller;
a light-emitting component placed inside the electrical household appliance; and
a light-guiding component arranged between the light-emitting component and the surface plate and comprising a light-guiding element and a first shielding element, said light-guiding element having a light incidence surface facing the light-emitting component, a light outflow surface facing the surface plate, and a side surface entirely surrounded by, and being in contact with, the first shielding element in such a manner that a light emitted by the light-emitting component flows into the light-guiding element through the light incidence surface and is led to the light outflow surface and to the side surface and is capable of flowing through the light outflow surface out of the electrical household appliance through the first visualisation window of the surface plate and the first shielding element blocks an outflow of light led to the side surface into the electrical household appliance,
wherein the light-guiding component is fixed to a plate inner face of the surface plate, at least over a part of the first shielding element surrounding the light-guiding element, in such a manner that the light emitted by the light-emitting component is capable of flowing out of the electrical household appliance only through the first visualisation window.

17. The electrical household appliance according to claim 16, wherein the light-guiding component is substantially plate-shaped.

18. The electrical household appliance according to claim 16, wherein the light-guiding element is in contact with the plate inner face of the surface plate.

19. The electrical household appliance according to claim 16, wherein the light-guiding component includes an orifice surrounding the opening and a second shielding element in contact with the plate inner face over an entire perimeter of the orifice in such a manner that the second shielding element blocks the outflow of light emitted by the light-emitting component led to the orifice towards the opening.

20. The electrical household appliance according to claim 16, wherein the surface plate comprises a second visualisation window through which the first shielding element is visible at least partially from outside the electrical household appliance, and the first shielding element blocks the light outflow through the second visualisation window in such a manner that a part of the first shielding element is visible through the second visualisation window and a part of the light-guiding element is visible through the first visualisation window.

21. The electrical household appliance according to claim 16, wherein the first shielding element covers at least a part of the light incidence surface of the light guiding element.

22. The electrical household appliance according to claim 16, wherein the first shielding element is made of an opaque material and preferably in a colour that is different from a colour of the surface plate.

23. (canceled)

24. The electrical household appliance according to claim 22, wherein at least a part of the first shielding element is an opaque solid piece, preferably made of plastic or the like, fitting in a positive-fit connection with the light-guiding element.

25. (canceled)

26. The electrical household appliance according to claim 22, wherein the first shielding element is an opaque paint layer and/or made of an opaque plastic piece and covers at least a part of the light outflow surface.

27. The electrical household appliance according to claim 20, wherein the first visualisation window and the second visualisation window are arranged around the opening.

28. The electrical household appliance according to claim 20, wherein the surface plate is made of a metal sheet and the first and second visualisation windows are sheet cut-outs.

29. The electrical household appliance according to claim 20, wherein the surface plate is made at least partially of an opaque glass and the first and second visualisation windows are transparent and/or translucent.

30. The electrical household appliance according to claim 16, comprising at least two of said operating arrangement placed in adjacent relationship.

31. The electrical household appliance according to claim 16, further comprising a shield designed to surround the light-emitting component at least partially and to lead light to the light-guiding element.

32. The electrical household appliance according to claim 16, further comprising a gas cooking appliance and the controller is a gas tap.
